(19) United States
(12) Patent Application Publication
(10) Pub. No.: US 2008/0028319 A1
(43) Pub. Date: Jan. 31, 2008

(54) Console-Integrated Updatable Terms

(76) Inventors: Aaron Roger Cox, Tucson, AZ (US); Brandon Joseph Herdrick, Tucson, AZ (US); Ralph Thomas Jackson, Tucson, AZ (US); Daniel Loewus-Deitch, Tucson, AZ (US); Mark E. Molander, Cary, NC (US); Teresa Shen Swingler, Tucson, AZ (US); Ronald Earl Van Buskirk, Boulder, CO (US)

Correspondence Address: IBM CORP. (WIP);c/o WALDER INTELLECTUAL PROPERTY LAW, P.C., P.O. BOX 832745, RICHARDSON, TX, 75083, US

(21) Appl. No.: 11/460,461

(22) Filed: Jul. 27, 2006

(51) Int. Cl. G06F 3/00

(52) U.S. Cl. 715/745

(57) ABSTRACT

An application console queries an updatable term service for updates to terms. The application then displays a current term, a legacy term, or a customized term according to user preferences. The application may also display a term indicator to notify the user that the term has an associated legacy term or current term. The user may also provide customized terms and descriptive text for updatable terms.

### BACKGROUND

1. Technical Field

The present application relates generally to an improved data processing system and method. More specifically, the present application is directed to a method, apparatus, program product, and service for updatable terms in a data processing system.

2. Description of Related Art

An important aspect of a software product is the taxonomy of terms in the product. Terms should be short and descriptive, not too general and not too specific. Terms should translate well to other languages and not be colloquial. Terms should also work together as a whole and work well with terms of similar existing products. However, the terms used in a software product are often designed by non-experts without sufficient attention to the taxonomy.

Another problem with terms used in software products is that they can instantly become entrenched, or “legacy.” In other words, once a term is established in a product and accepted by the user base, it is difficult to evolve the term into a more suitable term. In contrast, a difficult setup can be made easy by adding a new wizard, or a difficult item selection can be made easy by surfacing it in a new drop-down selection list. However, if a term is not working well, then it is much harder to change. Terms inevitably become hard coded in the messages, application programming interfaces (APIs), and all the associated books, helps, and learning modules. A product can fail simply because the terms used in the user interface, help modules, and the like are difficult to understand. Poor term quality also leads to user errors, user frustrations, and a bad user experience.

Poor cross-product synching of terms is especially a problem in storage. For example, the term “Volumes” has subtle, yet distinct differences in usage among various storage products. Companies have attempted to make terms consistent, but inevitably failed to make changes because of the legacy issues of terms.

### SUMMARY

In accordance with an illustrative embodiment, clients, as well as servers, may execute applications with updatable terms. In one exemplary embodiment, an updatable terms service provides access to updatable term data structures. An application may send a request for updates to the service, which returns available updates. The application may then apply those updates to user interface (UI) components within the application. If a term is updated, it has a legacy term and a current term with associated descriptive text. A term may also have a customized term, which defined by the user.

In one exemplary embodiment, the application allows the user to select whether the legacy term, the current term, or a customized term is displayed in the user interface component. If the user selects to display legacy terms, then the legacy term is displayed with a current term indicator. The current term indicator may be, for example, a graphical indicator or the current term in parentheses. If the user selects to display current terms, then the current term is displayed with a legacy term indicator. Term indicators may be interactive. For example, a user interface component may present a text box with descriptive text about the term when the user holds the mouse cursor over the term indicator.

In one illustrative embodiment, a computer program product comprising a computer usable medium having a computer readable program is provided. The computer readable program, when executed on a computing device, causes the computing device to create an instance of a user interface component in an application console. The user interface component includes a first updatable term from a set of updatable terms. The computer readable program may further causes the computing device to identify a surface level for the updatable term based on user preferences and display the surface level of the updatable term in the user interface component.

In an exemplary embodiment, the surface level for the updatable term is legacy, current, or customized. In another exemplary embodiment, the computer readable program further causes the computing device to display a term indicator in association with the updatable term, wherein the term indicator indicates a hidden level for the updatable term.

In yet another exemplary embodiment, the term indicator is a graphical indicator. In another exemplary embodiment, the term indicator is the hidden level of the updatable term in parentheses.

In a further exemplary embodiment, responsive to user activation of the term indicator, the computer readable program causes the computing device to display a description text associated with the updatable term.

In one exemplary embodiment, the set of updatable terms is stored in a term data structure. In another exemplary embodiment, the computer readable program further causes the computing device to request updates for the set of updatable terms from an updatable term service and responsive to receiving an update for an updatable term from the updatable term service, apply the update to the term data structure.

In another illustrative embodiment, an apparatus is provided that comprises a processor and a memory coupled to the processor. The memory contains instructions which, when executed by the processor, cause the processor to create an instance of a user interface component in an application console. The user interface component includes a first updatable term from a set of updatable terms. The instructions may further cause the processor to identify a surface level for the updatable term based on user preferences and display the surface level of the updatable term in the user interface component.

In a further illustrative embodiment, the memory may contain instructions which, when executed by the processor, cause the processor to perform one or more of the operations described above with regard to the computer readable program.

In a further illustrative embodiment, a method for providing a console-integrated updatable terms service is provided. The method comprises providing an updatable terms service computing device and providing an updatable terms service software on the updatable terms service computing device. The updatable terms service software is configured to, responsive to a request for a set of updatable terms from a client computing device, return an update to a term data structure at the client computing device, such that the client computing device creates an instance of a user interface component in an application console including a first updatable term from the set of updatable terms, identifies a surface level for the updatable term based on user preferences, and displays the surface level of the updatable term in the user interface component.

In a still further illustrative embodiment, a method for console-integrated updatable terms is provided. The method comprises creating an instance of a user interface component in an application console. The user interface component includes a first updatable term from a set of updatable terms. The method further comprises identifying a surface level for the updatable term based on user preferences and displaying the surface level of the updatable term in the user interface component.

In further exemplary embodiments, the method may comprise one or more of the operations described above with regard to the computer readable program.

These and other features and advantages of the present invention will be described in, or will become apparent to those of ordinary skill in the art in view of, the following detailed description of the exemplary embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 depicts a pictorial representation of an exemplary distributed data processing system in which aspects of the illustrative embodiments may be implemented;

FIG. 2 is a block diagram of an exemplary data processing system in which aspects of the illustrative embodiments may be implemented;

FIG. 3 is a block diagram illustrating the operation of an application with updatable terms in accordance with an illustrative embodiment;

FIGS. 4A-4F are example screens of display for an application with updatable terms in accordance with an illustrative embodiment;

FIG. 5 is a flowchart illustrating the operation of an application with updatable terms in accordance with an illustrative embodiment; and

FIG. 6 is a flowchart illustrating operation of an updatable term service in accordance with an illustrative embodiment.

### DETAILED DESCRIPTION OF THE ILLUSTRATIVE EMBODIMENTS

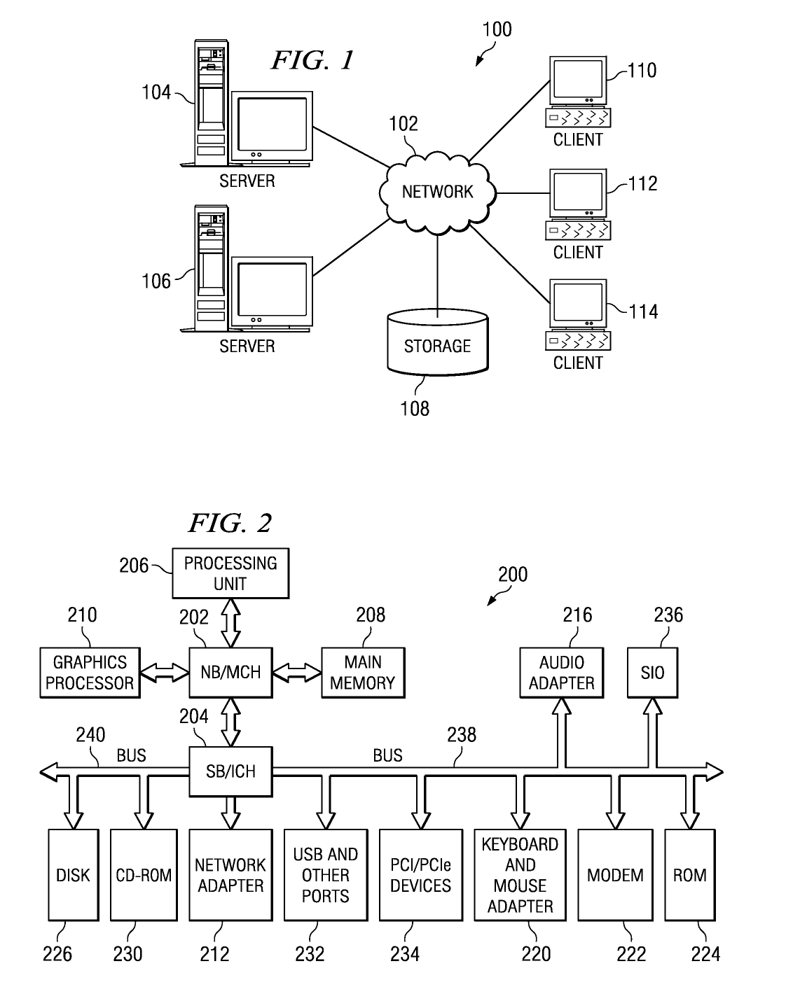

With reference now to the figures and in particular with reference to FIGS. 1-2, exemplary diagrams of data processing environments are provided in which embodiments of the present invention may be implemented. It should be appreciated that FIGS. 1-2 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of an exemplary distributed data processing system in which aspects of the illustrative embodiments may be implemented. Distributed data processing system 100 may include a network of computers in which embodiments of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In accordance with an illustrative embodiment, clients 110-114, as well as servers 104, 106, may execute applications with updatable terms. In one exemplary embodiment, server 104 provides access to updatable term data structures stored in storage 108. An application may send a request for updates to server 104, which returns available updates. The application may then apply those updates to user interface (UI) components within the application. If a term is updated, it has a legacy term and a current term with associated descriptive text. A term may also have a customized term, which defined by the user.

In one exemplary embodiment, the application allows the user to select whether the legacy term, the current term, or a customized term is displayed in the user interface component. If the user selects to display legacy terms, then the legacy term is displayed with a current term indicator. The current term indicator may be, for example, a graphical indicator or the current term in parentheses. If the user selects to display current terms, then the current term is displayed with a legacy term indicator. Term indicators may be interactive. For example, a user interface component may present a text box with descriptive text about the term when the user holds the mouse cursor over the term indicator.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

With reference now to FIG. 2, a block diagram of an exemplary data processing system is shown in which aspects of the illustrative embodiments may be implemented. Data processing system 200 is an example of a computer, such as server 104 or client 110 in FIG. 1, in which computer usable code or instructions implementing the processes for illustrative embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java™ programs or applications executing on data processing system 200 (Java is a trademark of Sun Microsystems, Inc. in the United States, other countries, or both).

As a server, data processing system 200 may be, for example, an IBM® eServer™ pSeries® computer system, running the Advanced Interactive Executive (AIX®) operating system or the LINUX® operating system (eServer, pSeries and AIX are trademarks of International Business Machines Corporation in the United States, other countries, or both while LINUX is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device which is configured with flash memory to provide non-volatile memory for storing operating system files and/or user-generated data, for example. Essentially, data processing system 200 may be any known or later developed data processing system without architectural limitation.

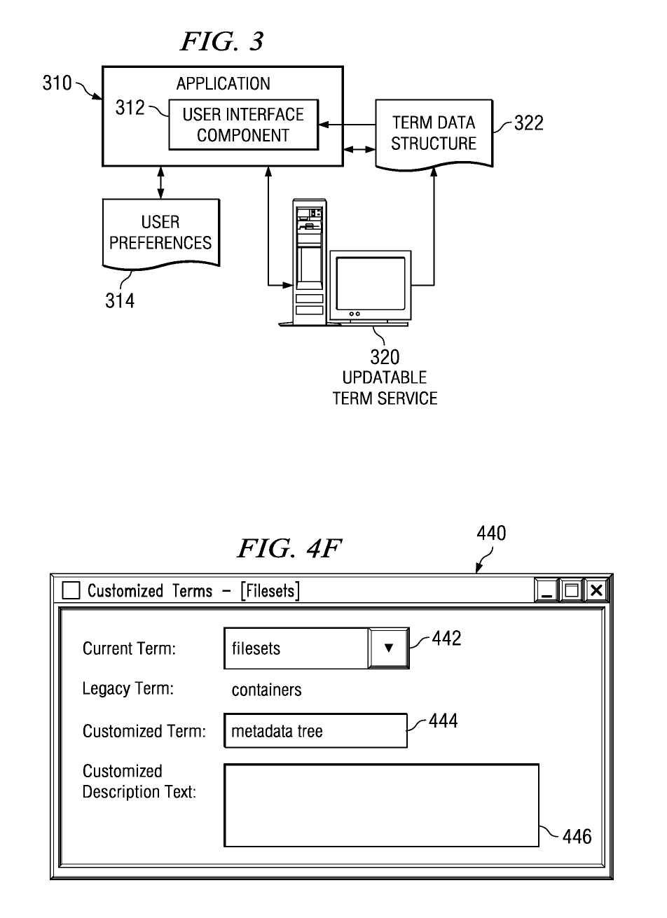

FIG. 3 is a block diagram illustrating the operation of an application with updatable terms in accordance with an illustrative embodiment. Application 310 has a user interface component, UI component 312, which includes updatable terms. Application 310 may run on a client device, such as clients 110-114 in FIG. 1 or a server, such as server 106 in FIG. 1, for example.

Application 310 submits a request for term updates to updatable term service 320. Updatable term service 320 may exist on server 104 in FIG. 1, for example. Responsive to an update request from application 310, updatable term service 320 returns term updates, which are applied to term data structure 322.

Application 310 presents a preferences dialog to the user. The preferences dialog may be accessible through a menu structure or the like. Application 310 stores settings from the preferences dialog in user preferences 314. Application 310 loads updatable terms from term data structure 322. When application 310 creates an instance of user interface component 312, application 310 displays a legacy term, a current term, or a customized term for each updatable term from term data structure 322, according to user preferences 314. For example, if the user sets updatable terms to “legacy,” then application 310 may create the instance of user interface component 312 with legacy terms displayed.

Furthermore, application 310 may display term indicators to notify the user that the term is updatable. For instance, if the user sets updatable terms to “current,” then application 310 may display a current term with a legacy term indicator. A term indicator may be a graphical indicator or some other indicator type, such as placing the legacy term in parentheses.

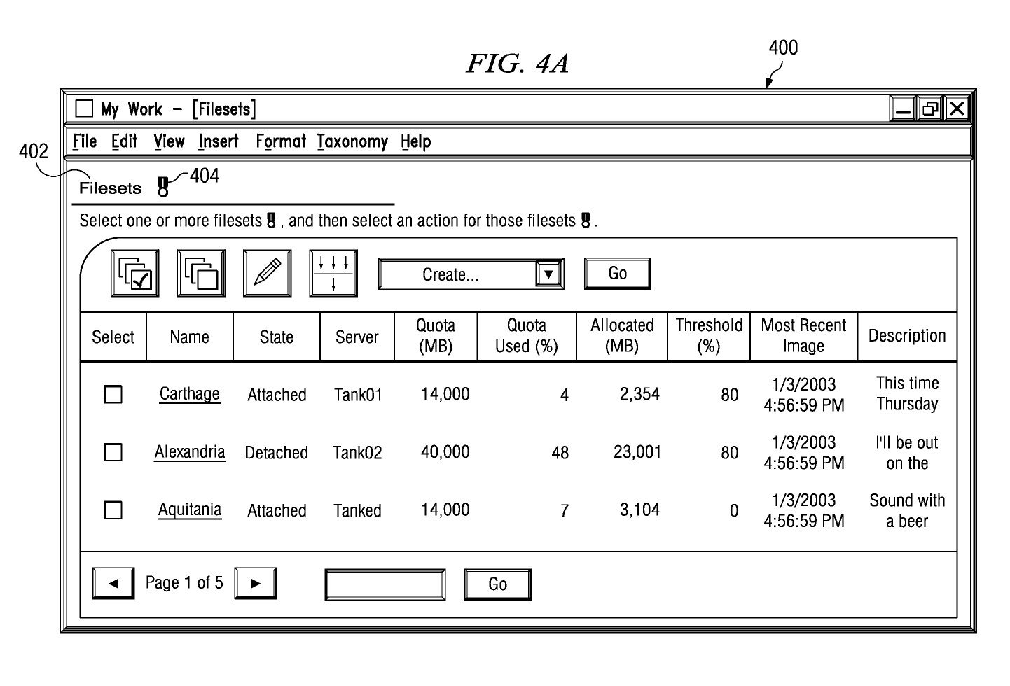

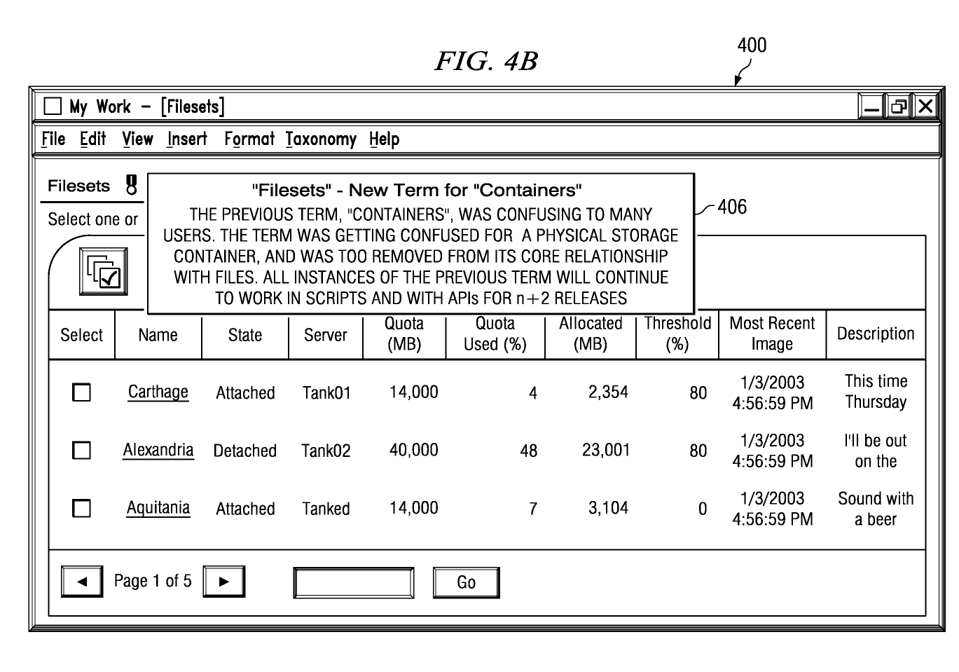

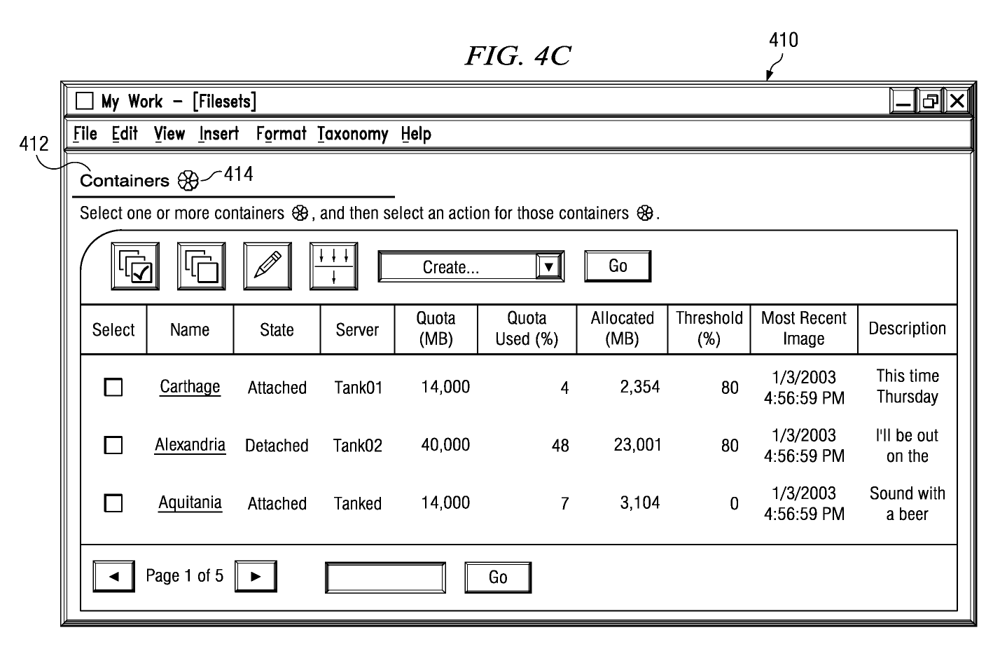

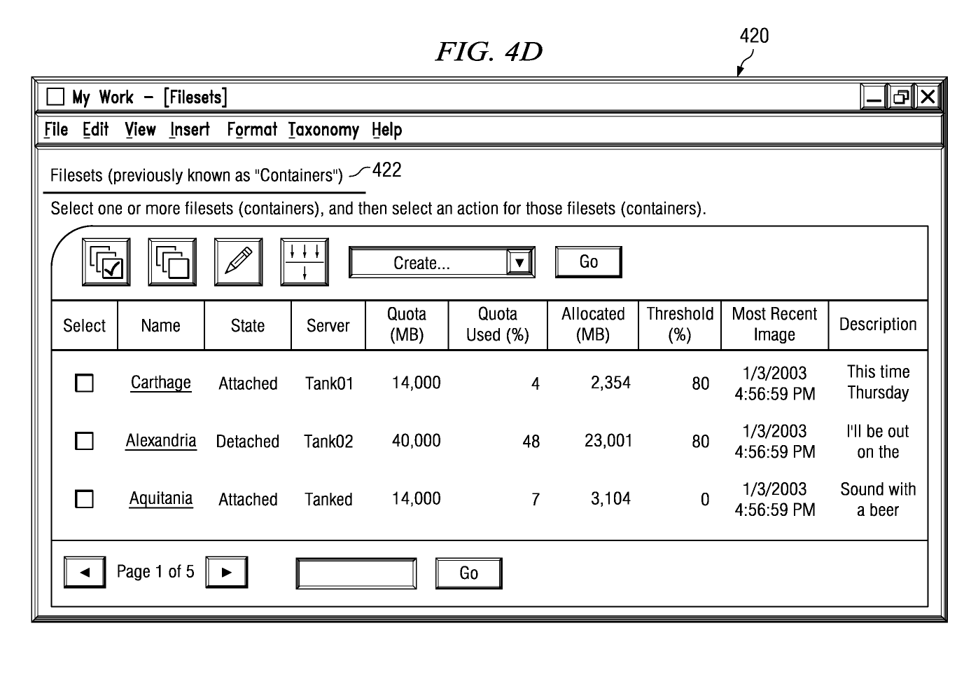

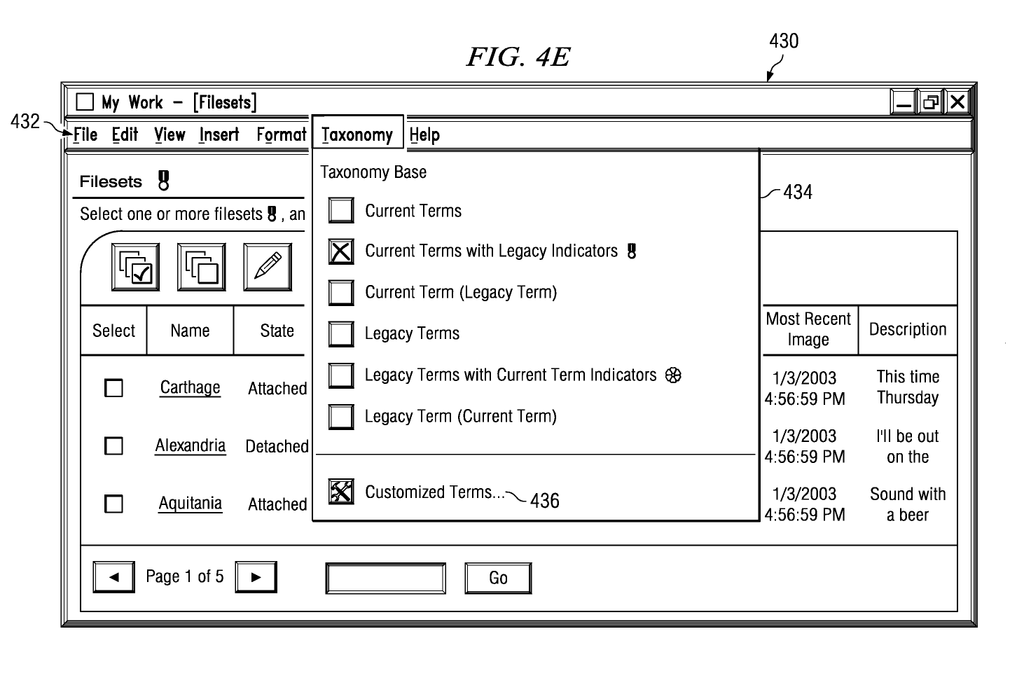

FIGS. 4A-4F are example screens of display for an application with updatable terms in accordance with an illustrative embodiment. More particularly, FIG. 4A illustrates an example screen of display for an application with a current term displayed. Application window 400 includes a user interface component with an updatable term 402. In the depicted example, the current term, “filesets,” is displayed. Legacy indicator 404 notifies the user that the displayed term has a legacy term.

FIG. 4B illustrates a text component that is displayed when a user activates legacy indicator 404. Application window 404 includes text description 406. The user may activate legacy indicator 404 by clicking on legacy indicator 404 or by holding the mouse cursor over the term indicator, for example.

Turning to FIG. 4C, application window 410 includes a user interface component with updatable term 412. In the depicted example, the legacy term, “containers,” is displayed. Current term indicator 414 notifies the user that the displayed term has a current term.

With reference now to FIG. 4D, application window 420 includes a user interface component with updatable term 422. In the depicted example, the current term is displayed and the legacy term is displayed in parentheses.

FIG. 4E illustrates an example screen of display for an application with a preferences interface. Application window includes menu bar 432. Taxonomy menu 434 presents selectable controls for the user to set taxonomy preferences. In the depicted example, the user selects “Current Terms with Legacy Indicators.” Taxonomy menu 434 may present the selectable controls for an individual term. Alternatively, the preferences selected in taxonomy menu 434 may be applied to all terms in the application.

Taxonomy menu 434 may also include a customized terms selection 436. Selection of the customized terms control 436 initializes a customized terms interface. FIG. 4F is an example screen of display for customized terms interface window 440. A user may select an updatable term in drop-down control 442. For a specified updatable term, the user may enter a customized term in text input control 444. The user may also enter a customized description text in text input control 446.

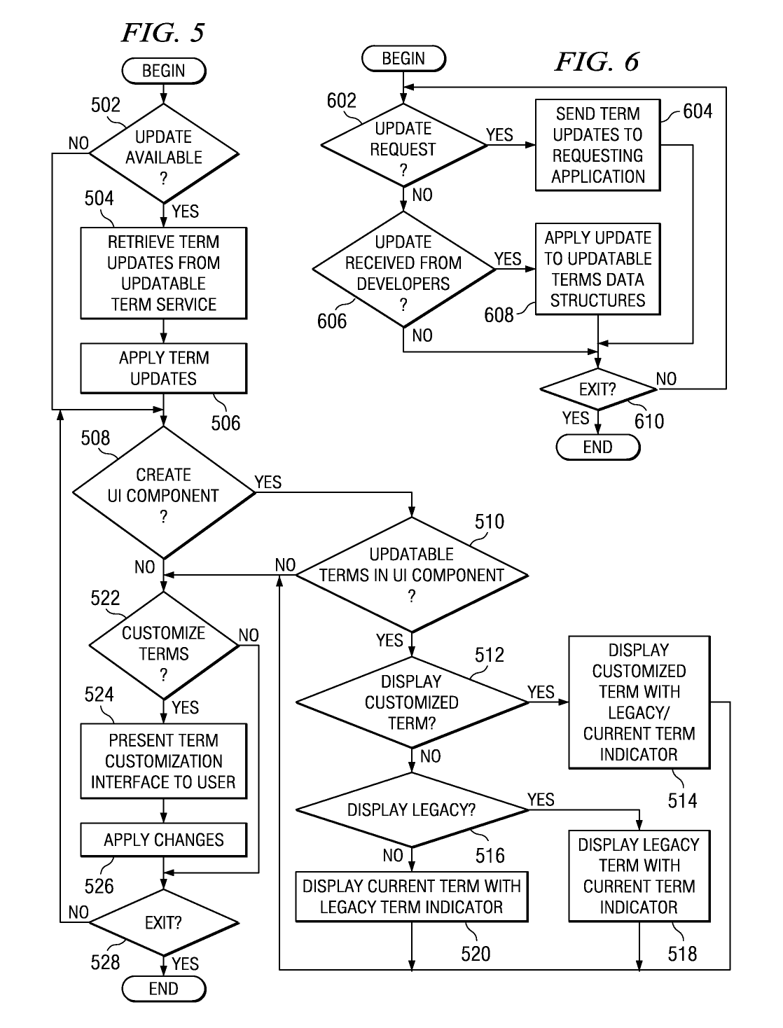

FIG. 5 is a flowchart illustrating the operation of an application with updatable terms in accordance with an illustrative embodiment. It will be understood that each block of the flowchart illustrations, and combinations of blocks in the flowchart illustrations, can be implemented by computer program instructions. These computer program instructions may be provided to a processor or other programmable data processing apparatus to produce a machine, such that the instructions which execute on the processor or other programmable data processing apparatus create means for implementing the functions specified in the flowchart block or blocks. These computer program instructions may also be stored in a computer-readable memory or storage medium that can direct a processor or other programmable data processing apparatus to function in a particular manner, such that the instructions stored in the computer-readable memory or storage medium produce an article of manufacture including instruction means which implement the functions specified in the flowchart block or blocks.

Accordingly, blocks of the flowchart illustrations support combinations of means for performing the specified functions, combinations of steps for performing the specified functions and program instruction means for performing the specified functions. It will also be understood that each block of the flowchart illustrations, and combinations of blocks in the flowchart illustrations, can be implemented by special purpose hardware-based computer systems which perform the specified functions or steps, or by combinations of special purpose hardware and computer instructions.

With reference now to FIG. 5, operation begins and the application determines whether updates are available for updatable terms (block 502). If updates are available, the application retrieves the updates from an updatable term service (block 504) and applies the term updates (block 506). Thereafter, or if updates are not available in block 502), the application determines whether an instance of a user interface component is to be created (block 508).

If the application creates an instance of a user interface component, the application determines whether there are updatable terms in the user interface component (block 510). If there are updatable terms in the user interface component, the application determines whether to display a customized term for the updatable term based on user preferences (block 512). If the user preferences indicate that a customized term is to be displayed, the application displays the customized term with legacy/current term indicators according to the user preferences (block 514). Thereafter, operation proceeds to block 522 to determine whether to display a customizable terms interface.

If the user preferences do not indicate that a customized term is to be displayed in block 512, the application determines whether to display a legacy term for the updatable term based on user preferences (block 516). If the user preferences indicate that a legacy term is to be displayed, the application displays the legacy term with a current term indicator according to the user preferences (block 518). Thereafter, operation proceeds to block 522 to determine whether to display a customizable terms interface.

If the user preferences do not indicate that a legacy term is to be displayed, the application displays the current term with a legacy indicator according to the user preferences (block 520). Thereafter, operation proceeds to block 522 to determine whether to display a customization interface.

If the application determines that the customizable terms interface is to be displayed, the application presents the term customization interface to the user (block 524). The user may interact with the customization interface to set customized terms and descriptive text for updatable terms. The application applies any changes made in the customization interface (block 526).

Thereafter, or if the application determines that the customization interface is not to be displayed in block 522, the application determines whether an exit condition exists (block 528). An exit condition may exist, for example, if the user closes the application. If an exit condition does not exist, operation returns to block 508 to determine whether an instance of a user interface component is to be created. If an exit condition does not exist in block 528, then operation ends.

FIG. 6 is a flowchart illustrating operation of an updatable term service in accordance with an illustrative embodiment. Operation begins and the updatable term service determines whether an update request is received from an application (block 602). If an update request is received, the updatable term service sends term updates to the requesting application (block 604). Thereafter, operation proceeds to block 610 to determine whether an exit condition exists.

If an update request is not received in block 602, the updatable term service determines whether an update is received from developers (block 606). Developers may continuously update terms and provide descriptive text to explain term changes to end users. If an update is received, the updatable term service applied the update to the updatable terms data structures (block 608). Thereafter, operation proceeds to block 610 to determine whether an exit condition exists.

If an update is not received from developers in block 606, the updatable term service determines whether an exit condition exists. An exit condition may exist, for example, if the service is brought offline. If an exit condition does not exist, operation returns to block 602 to determine whether an update request is received from an application. If an exit condition exists in block 610, then operation ends.

Thus, the illustrative embodiments solve the disadvantages of the prior art by providing console-integrated updatable terms. An application console queries an updatable term service for updates to terms. The application then displays a current term, a legacy term, or a customized term according to user preferences. The application may also display a term indicator to notify the user that the term has an associated legacy term or current term. The user may also provide customized terms and descriptive text for updatable terms.

It should be appreciated that the illustrative embodiments may take the form of an entirely hardware embodiment, an entirely software embodiment or an embodiment containing both hardware and software elements. In one exemplary embodiment, the mechanisms of the illustrative embodiments are implemented in software, which includes but is not limited to firmware, resident software, microcode, etc.

Furthermore, the illustrative embodiments may take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer program product comprising a computer useable medium having a computer readable program, wherein the computer readable program, when executed on a computing device, causes the computing device to:
create an instance of a user interface component in an application console, wherein the user interface component includes a first updatable term from a set of updatable terms;
identify a surface level for the updatable term based on user preferences; and
display the surface level of the updatable term in the user interface component.

2. The computer program product of claim 1, wherein the surface level for the updatable term is legacy, current, or customized.

3. The computer program product of claim 1, wherein the computer readable program further causes the computing device to display a term indicator in association with the updatable term, wherein the term indicator indicates a hidden level for the updatable term.

4. The computer program product of claim 3, wherein the term indicator is a graphical indicator.

5. The computer program product of claim 3, wherein the term indicator is the hidden level of the updatable term in parentheses.

6. The computer program product of claim 3, wherein responsive to user activation of the term indicator, the computer readable program causes the computing device to display a description text associated with the updatable term.

7. The computer program product of claim 1, wherein the set of updatable terms is stored in a term data structure.

8. The computer program product of claim 7, wherein the computer readable program further causes the computing device to:
request updates for the set of updatable terms from an updatable term service; and
responsive to receiving an update for an updatable term from the updatable term service, apply the update to the term data structure.

9. An apparatus, comprising:
a processor; and
a memory coupled to the processor, wherein the memory contains instructions which, when executed by the processor, cause the processor to:
create an instance of a user interface component in an application console, wherein the user interface component includes a first updatable term from a set of updatable terms;
identify a surface level for the updatable term based on user preferences; and
display the surface level of the updatable term in the user interface component.

10. The apparatus of claim 9, wherein the surface level for the updatable term is legacy, current, or customized.

11. The apparatus of claim 9, wherein the instructions further cause the processor to display a term indicator in association with the updatable term, wherein the term indicator indicates a hidden level for the updatable term.

12. The apparatus of claim 11, wherein responsive to user activation of the term indicator, the instructions cause the processor to display a description text associated with the updatable term.

13. The apparatus of claim 9, wherein the set of updatable terms is stored in a term data structure.

14. A method for providing a console-integrated updatable terms service, the method comprising:
providing an updatable terms service computing device; and
providing an updatable terms service software on the updatable terms service computing device, wherein the updatable terms service software is configured to:
responsive to a request for a set of updatable terms from a client computing device, return an update to a term data structure at the client computing device, such that the client computing device creates an instance of a user interface component in an application console including a first updatable term from the set of updatable terms, identifies a surface level for the updatable term based on user preferences, and displays the surface level of the updatable term in the user interface component.

15. A method for console-integrated updatable terms, the method comprising:
creating an instance of a user interface component in an application console, wherein the user interface component includes a first updatable term from a set of updatable terms;
identifying a surface level for the updatable term based on user preferences; and
displaying the surface level of the updatable term in the user interface component.

16. The method of claim 15, wherein the surface level for the updatable term is legacy, current, or customized.

17. The method of claim 15, further comprising:
displaying a term indicator in association with the updatable term, wherein the term indicator indicates a hidden level for the updatable term.

18. The method of claim 17, further comprising:
responsive to user activation of the term indicator, displaying a description text associated with the updatable term.

19. The method of claim 15, wherein the set of updatable terms is stored in a term data structure.

20. The method of claim 15, further comprising:
requesting updates for the set of updatable terms from an updatable term service; and
responsive to receiving an update for an updatable term from the updatable term service, applying the update to the term data structure.
